(19) United States
(12) Patent Application Publication
(10) Pub. No.: US 2026/0260237 A1
(43) Pub. Date: Sep. 3, 2026

(54) Automated Campaign Finance Compliance and Reporting System with Direct Bank Integration, AI-Enhanced Transaction Classification, and Adaptive Jurisdiction-Specific Compliance Mapping

(71) Applicant: CampaignFinance.App, Inc., Highland, IN (US)

(72) Inventor: BRANDON D M DOTHAGER, Highland, IN (US)

(73) Assignee: CampaignFinance.App, Inc., Highland, IN (US)

(21) Appl. No.: 19/554,498

(22) Filed: Mar. 2, 2026

Related U.S. Application Data
(60) Provisional application No. 63/765,537, filed on Mar. 1, 2025.

(51) Int. Cl. G06Q 20/38

(52) U.S. Cl. CPC G06Q 20/389; G06Q 20/382

(57) ABSTRACT

A computer-implemented campaign finance compliance system establishes authenticated connections to financial institution data interfaces and maintains a deduplicated transaction record through dual-path synchronization combining event-driven webhook notifications and scheduled cursor-based incremental retrieval with upsert-on-conflict deduplication. A classification engine evaluates normalized transaction records against configurable rule sets, including automated intermediary platform identification. A retroactive cross-report itemization module computes calendar-year-scoped contributor aggregates across multiple reports and retroactively updates itemization status on prior report entries when threshold crossings are detected. A split-transaction module decomposes aggregate bank deposits into constituent entries using a self-referential data model with automatic parent exclusion during report generation. A report generation module implements PDF form-field uniquification by appending page-index suffixes to AcroForm field names during multi-page template instantiation using a dual-document loading pattern isolating incompatible document state mutations. A database-to-application event pipeline uses database triggers with network extensions for asynchronous webhook invocation.

### CROSS-REFERENCE TO RELATED APPLICATIONS

This application claims the benefit of U.S. Provisional Application No. 63/765,537, filed Mar. 1, 2025, titled “CampaignFinance.App - -- Automated Campaign Finance Compliance and Reporting System with Direct Bank Integration, AI-Enhanced Transaction Classification, Adaptive State and Local Compliance Mapping, and FinTech Innovations for Down-Ballot Campaigns,” the entire contents of which are incorporated herein by reference.

### FIELD OF THE INVENTION

The present invention relates to computer-implemented financial compliance systems and, more particularly, to machine-implemented systems and methods for automated ingestion, normalization, classification, validation, compliance-mapped reporting, and regulatory-form generation of financial transaction data for political committees subject to campaign finance disclosure requirements. The invention further relates to techniques for dynamic document generation including form-field uniquification for multi-page template instantiation, retroactive cross-report itemization determination, and self-referential split-transaction data modeling.

### BACKGROUND OF THE INVENTION

### Technical Context

Campaign finance reporting obligations require political committees to collect, categorize, and disclose financial transactions—including contributions received, expenditures made, refunds, transfers between accounts, and in-kind contributions—according to schedules and formats prescribed by federal, state, and local election authorities. The applicable rules vary substantially by jurisdiction in terms of reporting thresholds, required contributor attributes, schedule structures, filing frequencies, and permissible formats for submission.

Despite the technical complexity of these obligations, the tools historically available to down-ballot campaigns and small political committees have been primitive relative to the compliance burden. Treasurers have typically relied on spreadsheets, manual bank-statement review, and disconnected data entry to compile filings. This workflow requires repeated manual reconciliation of downloaded financial data against internally maintained ledgers, manual classification of each transaction into the correct reporting category, manual population of jurisdiction-specific form fields, and repeated rework when classifications are later found to be incorrect or when required contributor attributes are discovered to be missing.

### Technical Deficiencies in Prior Approaches

The fragmented nature of prior workflows introduces several categories of technical problems that are not merely administrative inconveniences but represent structural deficiencies in how financial data is processed, reconciled, and transformed into compliant outputs.

First, financial data retrieval has historically required periodic manual export-and-import operations, creating temporal gaps in the transaction record between export cycles and increasing the probability of omitted or duplicated entries. No mechanism has existed for maintaining a continuously synchronized, deduplicated transaction record that combines event-driven notifications with periodic retrieval to ensure completeness.

Second, transaction classification has been performed without systematic rule application, resulting in inconsistent categorization across reporting periods. Prior tools have not implemented cross-report, calendar-year-scoped itemization determination, in which the system evaluates whether a contributor's aggregate year-to-date contribution total exceeds an applicable threshold by scanning transaction entries across all reports filed within the same calendar year not merely entries within the current report. This cross-report scope is significant because a contributor whose individual contributions are each below the threshold may still require itemized disclosure when their cumulative total exceeds the threshold, and this determination may retroactively affect entries in previously filed reports.

Third, regulatory filing forms in many jurisdictions use structured PDF documents with pre-defined form fields (AcroForm fields). When a single reporting period requires multiple pages of the same schedule type—for example, when a committee has more itemized contributions than can fit on a single Schedule A page—each additional page must be instantiated from the same PDF template. However, standard PDF form-field technology assigns a single global name to each field, meaning that multiple instantiations of the same template page within a single document will produce duplicate field names, causing field-value collisions in which a value entered in one page instance overwrites the corresponding field on all other instances. Prior tools have not implemented automated field-name uniquification during multi-page template instantiation.

Fourth, prior tools have not provided a mechanism for modeling split transactions cases where a single bank transaction (such as a deposit containing multiple individual contributions) must be decomposed into its constituent parts for compliance reporting. Specifically, no mechanism has existed for a self-referential transaction record model in which child entries reference their parent entry through a foreign key relationship, with automatic exclusion of parent entries from the filing output when child entries are present, to prevent double-counting.

Fifth, prior systems have not implemented automated identification of transactions originating from known contribution aggregation platforms (such as ActBlue or similar intermediaries) with automatic reclassification of the intermediary entity as the contributor, normalizing the display name to the platform's standard identifier. This identification has been performed manually.

These deficiencies collectively result in compliance workflows that are error-prone, labor-intensive, and poorly suited to the regulatory demands placed on even small-scale political committees.

### SUMMARY OF THE INVENTION

The present invention provides a computer-implemented campaign finance compliance and reporting system that addresses the foregoing technical deficiencies through an integrated architecture comprising the following principal technical components.

A bank data integration module establishes authenticated connections to one or more financial institution data interfaces and retrieves transaction records associated with campaign committee bank accounts. In some embodiments, authentication uses mutual Transport Layer Security (mTLS) with client certificates. In other embodiments, authentication uses OAuth-based token exchange. Access tokens obtained through end-user enrollment are stored in association with the corresponding committee account and are used to authenticate subsequent retrieval requests.

A synchronization engine maintains the completeness and currency of the transaction record through at least two independent mechanisms. A first event-driven synchronization path receives webhook notifications from the financial data interface when new transactions are posted. A second scheduled synchronization path periodically retrieves transaction records through authenticated API requests. Records received through both paths are reconciled into a deduplicated transaction store using cursor-based incremental retrieval with upsert-on-conflict deduplication to prevent duplicate entries.

A classification engine evaluates each normalized transaction record against configurable rule sets to assign campaign finance transaction classification categories. The classification engine includes an automated intermediary identification module that detects transactions originating from known contribution aggregation platforms by comparing the merchant name field against stored platform identifier strings, and reclassifies such transactions with the platform as the contributor entity.

A retroactive cross-report itemization module determines, for each contributor within a calendar year, whether the contributor's aggregate year-to-date contribution total exceeds the applicable itemization threshold. This determination scans transaction entries across all reports filed within the same calendar year—not merely entries within the current report. When a new contribution causes a contributor's cumulative total to exceed the threshold, the system retroactively updates the itemization status of that contributor's entries in prior reports within the same calendar year.

A split-transaction module enables decomposition of a single bank transaction into multiple constituent entries using a self-referential data model in which child entries reference their parent entry through a foreign key. The report generation module automatically excludes parent entries from the filing output when one or more child entries are present, preventing double-counting.

A report generation module produces filing-ready outputs including PDF documents formatted in accordance with jurisdiction-specific regulatory forms. The PDF generation module implements a form-field uniquification technique in which, during multi-page template instantiation, each AcroForm field name in each instantiated page is appended with a page-index suffix, ensuring globally unique field names across all pages of the generated document and preventing field-value collisions.

A document storage module stores generated filing artifacts in S3-compatible object storage with metadata supporting retrieval, audit, and regeneration.

A database-to-application event pipeline uses a PostgreSQL trigger that fires upon user registration events and invokes an asynchronous HTTP POST to the application's webhook endpoint, enabling decoupled post-registration processing without polling or queue infrastructure.

### BRIEF DESCRIPTION OF THE DRAWINGS

FIG. 1 is a block diagram illustrating the overall system architecture of the campaign finance compliance and reporting system, showing the principal modules and their interconnections.

FIG. 2 is a data flow diagram illustrating the end-to-end processing pipeline from bank data ingestion through filing output generation.

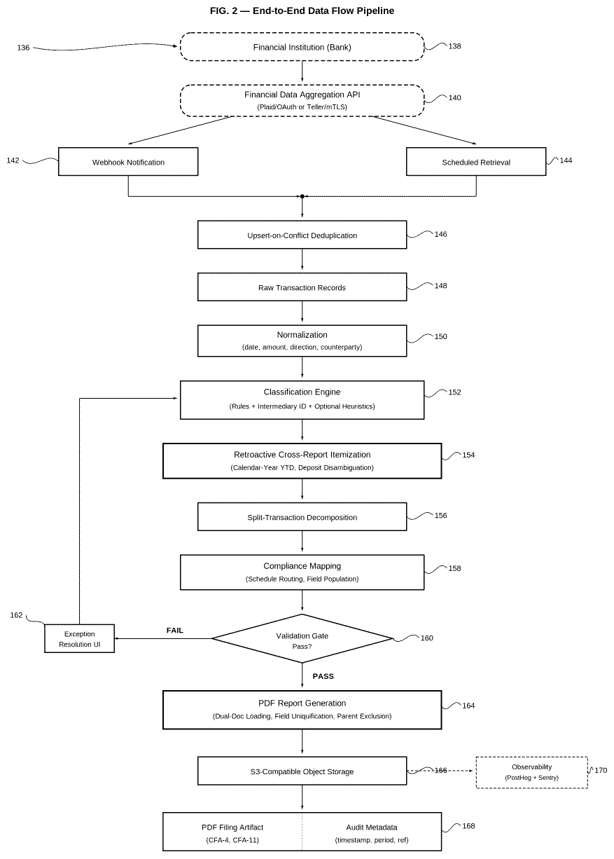

FIG. 3 is a sequence diagram illustrating the bank data integration and authentication workflow, including both mutual TLS and OAuth-based authentication embodiments.

FIG. 4 is a diagram illustrating the dual-path synchronization architecture, including the event-driven webhook path, the scheduled retrieval path, and the cursor-based incremental reconciliation mechanism.

FIG. 5 is a database schema diagram illustrating the principal data tables, relationships, and key fields, including the schedule_a_entries table with UUID primary keys, the split_parent_entry_id self-referential foreign key, and the is_itemized field.

FIG. 6 is a flowchart illustrating the retroactive cross-report itemization determination process, including calendar-year-scoped contributor aggregation and retroactive update of prior report entries.

FIG. 7 is a flowchart illustrating the split-transaction decomposition workflow, including parent-child relationship creation and automatic parent exclusion during report generation.

FIG. 8 is a diagram illustrating the PDF form-field uniquification technique during multi-page template instantiation, showing the dual-document loading pattern and page-index suffix appending.

FIG. 9 is a flowchart illustrating the transaction classification workflow, including automated intermediary platform identification and rule-based classification.

FIG. 10 is a flowchart illustrating the report generation workflow, including the validation gate, PDF document assembly, and storage with generation metadata.

FIG. 11 is a sequence diagram illustrating the database-to-application event pipeline using PostgreSQL pg_net trigger for asynchronous post-registration processing.

FIG. 12 is a diagram illustrating the deposit placeholder disambiguation mechanism in the itemization calculation, showing entry-ID-based grouping for deposit transactions versus contributor-name-based grouping for non-deposit transactions.

### DETAILED DESCRIPTION OF THE INVENTION

### I. Overview

The following detailed description sets forth specific embodiments of a computer-implemented campaign finance compliance and reporting system (hereinafter “the system”). The system is implemented on one or more computing devices executing software modules that collectively automate the ingestion, normalization, storage, classification, compliance mapping, validation, and output generation of campaign financial transaction data. The system produces filing-ready output artifacts—including PDF documents formatted in accordance with jurisdiction-specific regulatory forms—from raw bank transaction data, reducing the manual effort required to compile compliant campaign finance filings.

While certain embodiments are described with reference to specific technologies, vendor services, data formats, and implementation details, the invention is not limited to these particular implementations. Alternative technologies, architectures, and configurations that perform equivalent functions fall within the scope of the invention as defined by the claims.

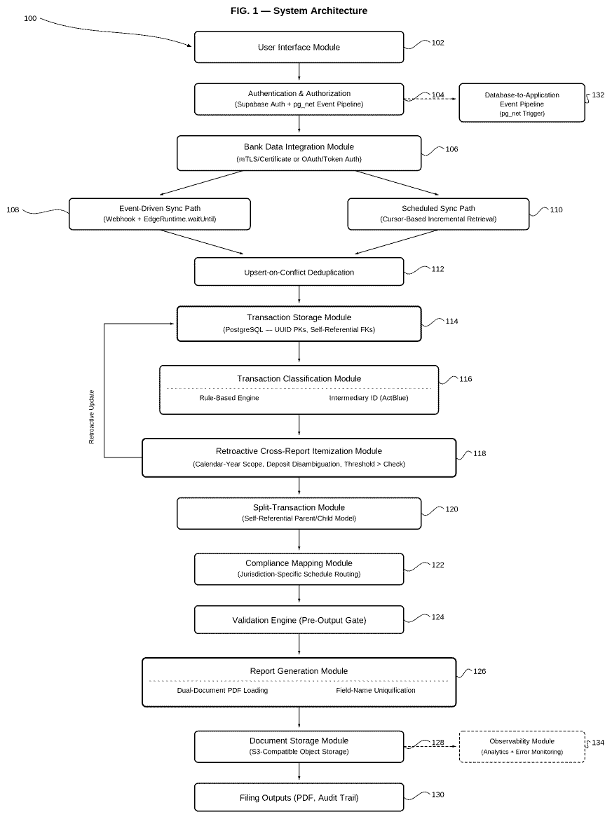

### II. System Architecture (FIG. 1)

Referring to FIG. 1, the system (100) comprises: a user interface module (102); an authentication and authorization module (104); a bank data integration module (106); a dual-path synchronization engine comprising an event-driven synchronization path (108) and a scheduled synchronization path (110); an upsert-on-conflict deduplication module (112); a transaction storage module (114); a transaction classification module (116); a retroactive cross-report itemization module (118); a split-transaction module (120); a compliance mapping module (122); a validation engine (124); a report generation module (126); a document storage module (128); filing outputs (130); a database-to-application event pipeline (132); and an observability module (134).

In some embodiments, the system is implemented as a full-stack web application using a JavaScript/TypeScript framework providing both server-side rendering for optimized initial page loads and client-optimized rendering for interactive workflows. The relational database, authentication service, and object storage service are provided by an integrated backend platform. In one embodiment, the database is PostgreSQL hosted by Supabase, authentication is provided by Supabase Auth, and object storage uses Supabase Storage (S3-compatible).

### III. Authentication and Authorization Module

The authentication and authorization module (104) controls access to the system. User authentication is performed through the integrated authentication service, which issues and validates session tokens. In one embodiment, upon user registration, a PostgreSQL trigger fires on the auth. users table and invokes the pg_net extension's http_post( ) function to send an asynchronous HTTP POST request to the application's internal webhook endpoint (e.g., /api/webhooks/auth), authenticated using a secret stored in the database vault. The webhook payload includes the event type and user identifier. The application's webhook handler processes the registration event asynchronously—performing operations such as welcome email dispatch, analytics event capture, and external contact creation—without blocking the user registration flow and without requiring application-level polling or external queue infrastructure. In one embodiment, a three-minute timeout is configured for the HTTP POST invocation.

In some embodiments, the webhook handler employs an edge-runtime asynchronous continuation pattern (e.g., EdgeRuntime. waitUntil( )) to immediately acknowledge receipt of the webhook event and then perform the post-registration processing operations asynchronously, decoupling the webhook response latency from the processing duration.

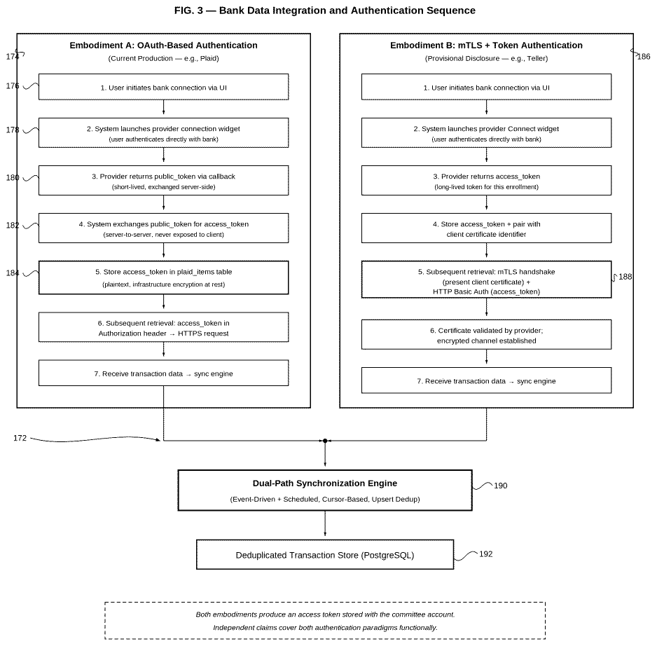

### IV. Bank Data Integration Module (FIG. 3)

The bank data integration module (106) establishes and maintains programmatic connections to one or more financial institution data interfaces and retrieves transaction and account data through authenticated connections.

In a first embodiment (as described in the provisional application), the integration module communicates with a financial data aggregation API (140) that requires mutual Transport Layer Security (mTLS) authentication (186). The system presents a client certificate issued by the financial data interface provider to authenticate its identity (188) before any data transfer occurs. An access token obtained through an end-user enrollment flow is paired with the client certificate and transmitted using HTTP Basic Authentication encoding.

In a second embodiment (as currently implemented in production), the integration module communicates with a financial data aggregation API (140) that uses OAuth-based authentication (174). The end user completes an enrollment flow through the provider's connection widget (178), during which the user authenticates directly with their financial institution. Upon successful enrollment, the provider returns a public token (180), which the system exchanges for an access token (182). The access token is stored (184) by the system in association with the corresponding committee account record in a dedicated table (e.g., plaid_items (220)) in the relational database, with data-at-rest encryption provided by the database infrastructure. In some embodiments, application-layer encryption of the access token may additionally be applied.

In both embodiments, the enrollment flow results in the system obtaining authorization to retrieve transaction and account data for one or more bank accounts associated with the political committee. The stored access token is used to authenticate subsequent retrieval requests through the dual-path synchronization engine (190), which maintains a deduplicated transaction store (192).

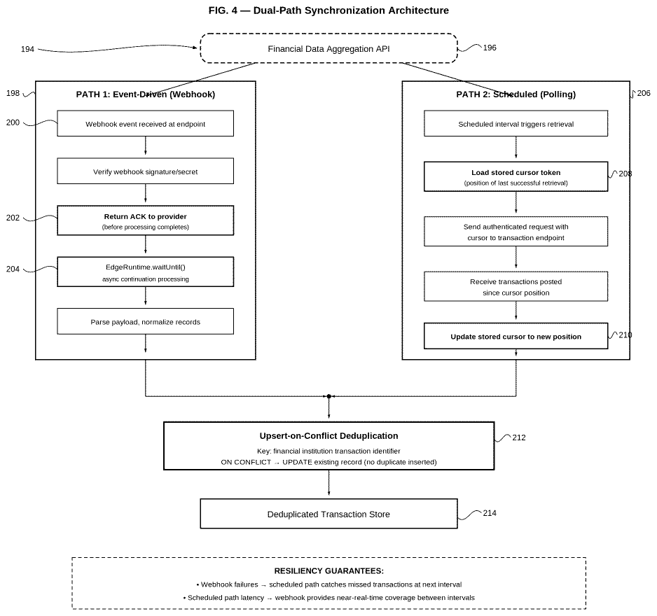

### V. Dual-path Synchronization Engine (FIG. 4)

The dual-path synchronization engine (194) maintains the completeness and currency of the transaction record through two independent and complementary synchronization mechanisms operating in parallel, communicating with the financial data aggregation API (196).

The first mechanism, referred to as the event-driven synchronization path (198), receives real-time or near-real-time transaction notifications delivered by the financial data interface through a webhook endpoint (200) maintained by the system. When a webhook event is received and authenticated, the synchronization engine parses the event payload, extracts the relevant transaction data, normalizes the records, and stores them in the transaction store. In some embodiments, the webhook handler returns an acknowledgment to the provider before processing (202) and employs an asynchronous continuation pattern (204) (e.g., EdgeRuntime. waitUntil( )) to perform the synchronization processing asynchronously, preventing timeout failures when synchronization processing exceeds the financial data interface's expected response time.

The second mechanism, referred to as the scheduled synchronization path (206), operates on a periodic basis by dispatching authenticated requests to the financial data interface's transaction history endpoints. In one embodiment, the scheduled path uses cursor-based incremental retrieval, in which a stored cursor token (208) representing the position of the most recently retrieved transaction is included in subsequent retrieval requests, enabling the system to retrieve only transactions posted since the prior retrieval without re-fetching the entire transaction history. The cursor is updated to a new position (210) after each successful retrieval.

The synchronization engine reconciles records received through both paths against the existing deduplicated transaction store (214) using an upsert-on-conflict deduplication engine (212). In one embodiment, deduplication is performed using an upsert-on-conflict operation keyed on the financial institution's unique transaction identifier: when a transaction record is received that matches an existing record's external identifier, the existing record is updated rather than a duplicate being inserted. The dual-path architecture ensures that transaction records missed by the event-driven path due to webhook delivery failures, network interruptions, or endpoint unavailability are captured by the scheduled path, and conversely that time-sensitive transactions are available in the system ahead of the next scheduled retrieval window.

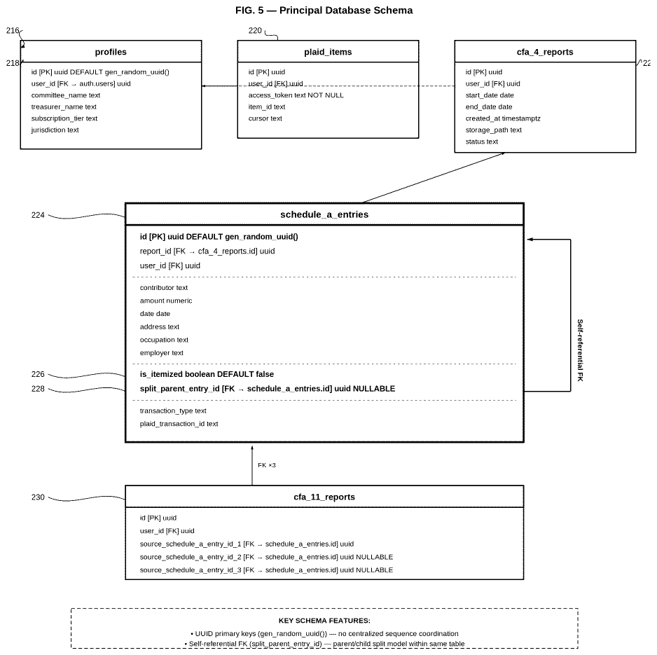

### VI. Transaction Storage Module (FIG. 5)

The transaction storage module (114) maintains all normalized transaction records, associated metadata, and system state in a relational database (216). In one embodiment, each record in the transaction store is assigned a universally unique identifier (UUID) generated at record creation time using a database-native function (e.g., gen_random_uuid( )), enabling distributed record creation without centralized sequence coordination and supporting stable cross-reference between related records including split-transaction parent-child relationships.

The schema (216) includes tables for: committee accounts and profiles (218); connected bank account records with associated access tokens (220); CFA-4 report records (222) associating generated filings with date ranges and committees; schedule A entries (224) (contribution records) with classification, an itemization status field (226), contributor attributes, and a split-transaction self-referential foreign key (228); CFA-11 supplemental disclosure report records (230); and generated filing artifacts with storage references and generation metadata.

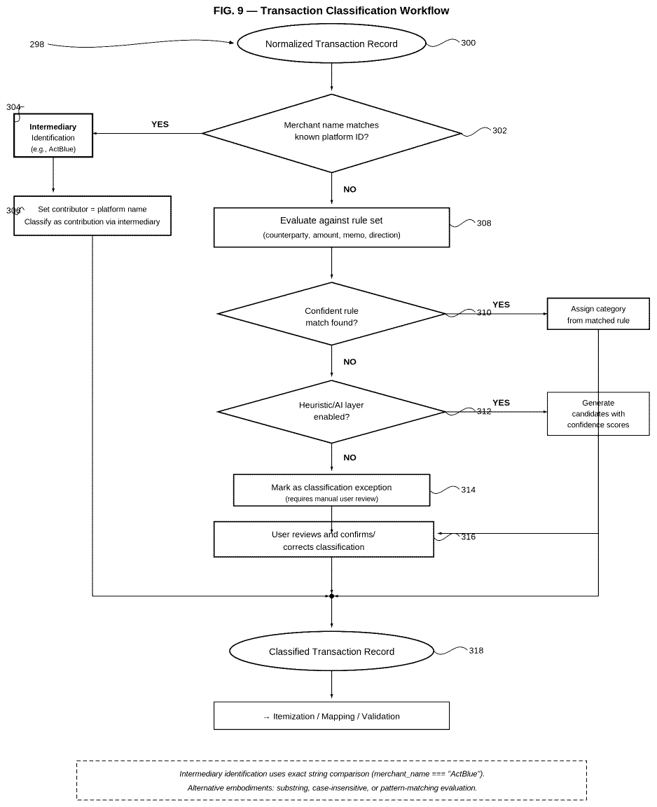

### VII. Transaction Classification Module (FIG. 9)

The transaction classification module (116) assigns campaign finance transaction categories to normalized transaction records (300). Campaign finance transaction categories include, without limitation: monetary contribution, in-kind contribution, monetary expenditure, loan received, loan repayment, refund of contribution, refund of expenditure, transfer between affiliated accounts, and miscellaneous receipt or disbursement.

### A. Automated Intermediary Platform Identification

The classification module includes an automated intermediary identification sub-module (304) that identifies transactions originating from known contribution aggregation platforms. In one embodiment, the sub-module evaluates whether the merchant name field of each transaction record matches one or more stored platform identifier strings (302). In one implementation, the evaluation comprises an exact string equality comparison. In alternative implementations, the evaluation comprises a substring containment check, a case-insensitive comparison, or a pattern-matching operation. When a match is detected, the classification module automatically reclassifies the transaction (306) by designating the aggregation platform as the contributor entity and normalizing the contributor display name to the platform's standard identifier.

### B. Rule-Based Classification

Classification is performed by evaluating each normalized record against one or more stored rule sets (308). In some embodiments, rule sets comprise ordered sequences of conditions evaluated against transaction record fields, including counterparty identifier, transaction amount, direction indicator, and memo field content. A rule that matches a transaction record (310) assigns the record a classification category, producing a classified transaction record (318).

### C. Heuristic and AI-Assisted Classification (Optional)

In some embodiments, when no rule in the active rule set yields a confident classification for a given record, the classification module checks whether a heuristic or AI layer is enabled (312). If enabled, the module invokes an optional heuristic analysis layer that examines transaction attributes—including counterparty name patterns, amount ranges, memo field tokens, and prior classification decisions for transactions having similar attributes—to surface one or more candidate classification categories with associated confidence scores for presentation to an authorized user through a review interface (316). In some embodiments, this heuristic layer may incorporate a trained machine-learning model or a large language model invoked via API. The candidate classifications surfaced by the heuristic layer are presented to the user for confirmation or correction; the system does not automatically apply a heuristic classification without user approval unless the confidence score exceeds a configurable threshold. When the heuristic layer is not enabled or does not produce a result, the record is marked as a classification exception requiring manual review (314).

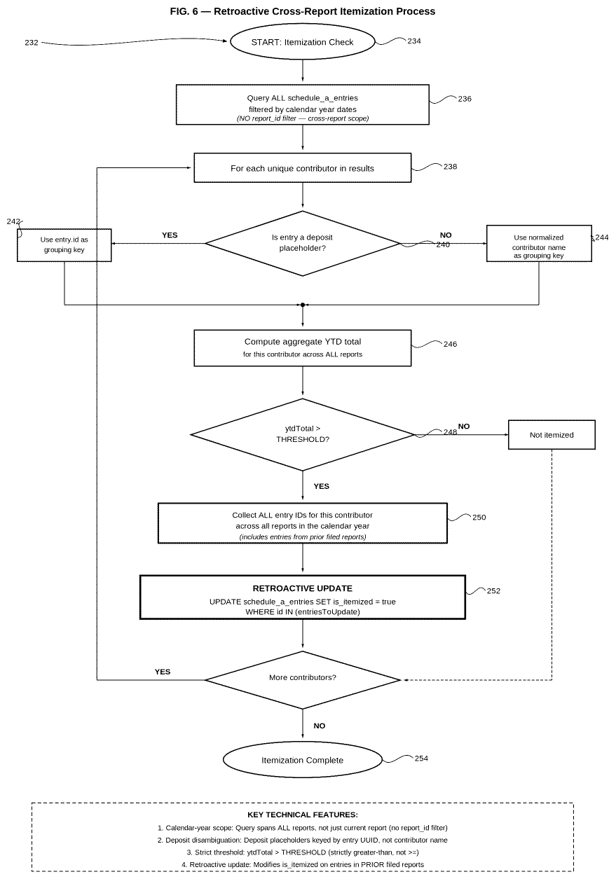

### VIII. Retroactive Cross-report Itemization Module (FIG. 6)

The retroactive cross-report itemization module (118, 232) is a technically significant component of the system that addresses the itemization determination problem in campaign finance reporting. Many jurisdictions require that contributions from a single contributor be reported in itemized detail (including contributor name, address, occupation, and employer) when the contributor's aggregate year-to-date contributions exceed a defined threshold. Below this threshold, contributions may be reported in summary form.

### A. Calendar-Year-Scoped Contributor Aggregation

The itemization module begins an itemization check (234) by querying all schedule A entries for the calendar year without filtering by report identifier (236). For each unique contributor (238), the module computes the aggregate year-to-date contribution total. The contributor's name is normalized to a canonical form (244) for aggregation purposes. This cross-report scope means the system considers entries across all reports filed for the same calendar year, not merely entries within the report currently being generated.

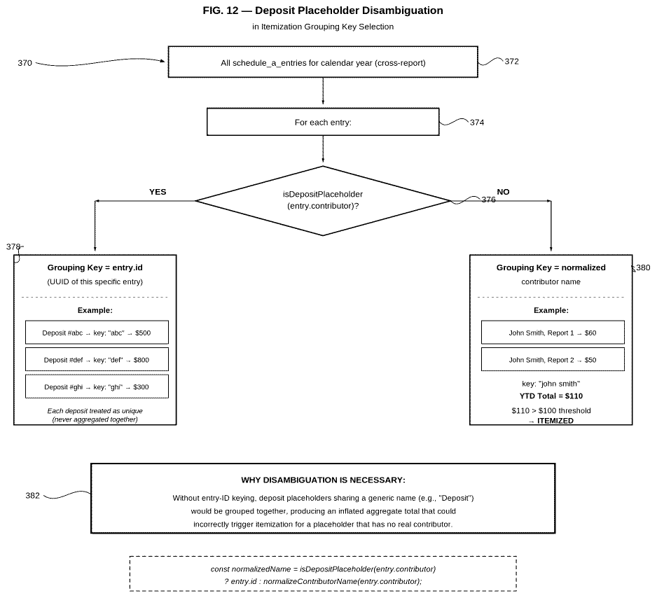

### B. Deposit Placeholder Disambiguation (FIG. 12)

The deposit placeholder disambiguation mechanism (370) operates across all schedule A entries for the calendar year with cross-report scope (372). For each entry (374), the module determines whether the entry represents a deposit placeholder by evaluating isDepositPlaceholder(entry. contributor) (376). When the entry represents a deposit placeholder, the itemization module uses the entry's unique identifier (UUID) as the grouping key (378) instead of the normalized contributor name (380). This prevents deposit placeholders from being incorrectly aggregated with named contributors or with each other, which would produce inflated year-to-date totals and incorrect itemization determinations (382).

### C. Threshold Comparison and Retroactive Update

The itemization module computes the aggregate year-to-date total across all reports for each contributor (246) and determines whether each contributor's aggregate total exceeds the applicable itemization threshold (248). A contributor whose aggregate total exceeds the threshold is marked as requiring itemized disclosure. Critically, when a new contribution causes a contributor's year-to-date total to cross the threshold, the system collects all entry IDs across all reports for that contributor (250) and retroactively updates the is_itemized field to true (252) on that contributor's entries in prior reports within the same calendar year. These prior entries may belong to reports that have already been filed and for which PDF artifacts have already been generated. The retroactive update ensures that if a report is regenerated, the regenerated output will correctly reflect the updated itemization status. The process completes at the itemization complete end state (254).

In the current implementation, the itemization module is invoked manually by the user through the interface. In some embodiments, the itemization module may be invoked automatically at report creation time. The report creation function also includes inline itemization logic (330) that performs the threshold determination as part of the report generation workflow.

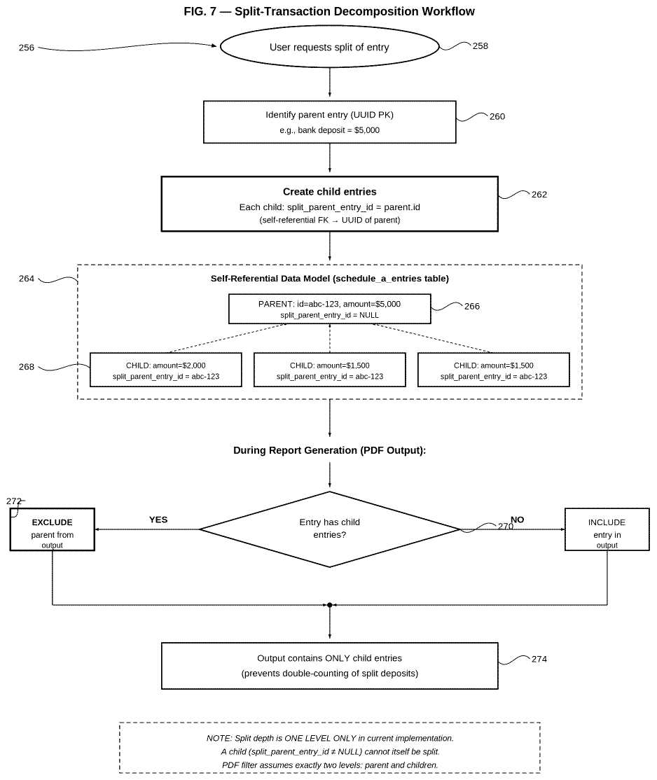

### IX. Split-Transaction Module (FIG. 7)

The split-transaction module (120, 256) enables decomposition of a single bank transaction into multiple constituent entries for compliance reporting. This addresses the common scenario in which a single bank deposit contains multiple individual contributions that must be separately reported.

When a user requests a split of an entry (258), the system identifies the parent entry by its UUID primary key (260). The split-transaction module uses a self-referential data model (264) in which each child entry's split_parent_entry_id field is set to the parent's ID (262). The parent record has split_parent_entry_id=NULL (266), while child entry records (268) reference the parent. Child entries created through the split operation inherit certain attributes from the parent and are individually classified, mapped, and reported.

In the current implementation, the split depth is one level: a parent entry may be split into one or more child entries, but a child entry (one for which split_parent_entry_id is not null) cannot itself be split into further children. During PDF generation, the module checks whether child entries exist for each parent (270). When one or more child entries referencing that parent are present, the parent entry is excluded from the filing output (272), preventing double-counting of the underlying transaction amount. The output contains only child entries (274) when split children exist.

In some embodiments, recursive splitting may be supported, in which a child entry may itself serve as a parent for further decomposition, enabling multi-level transaction trees.

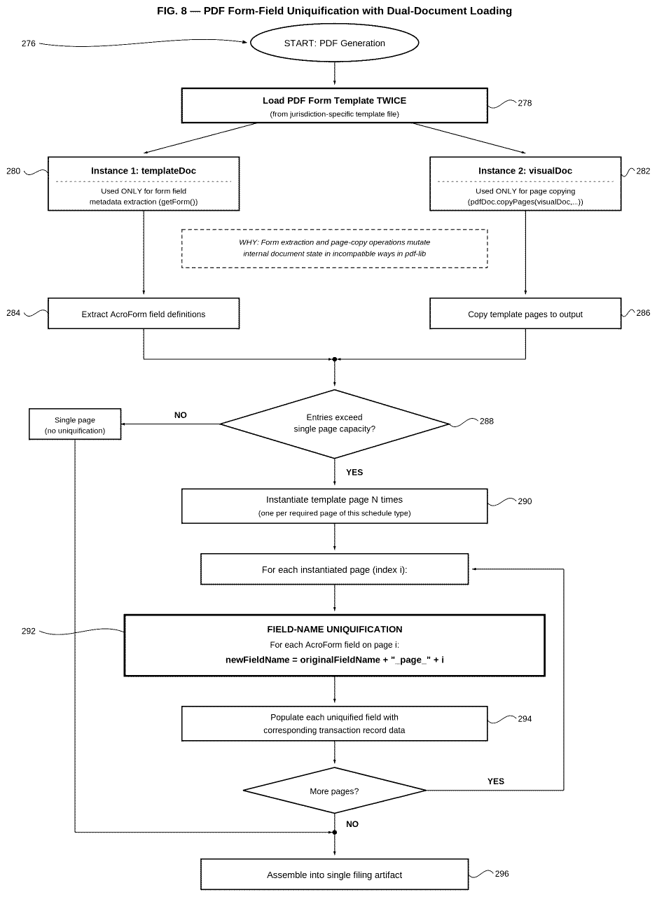

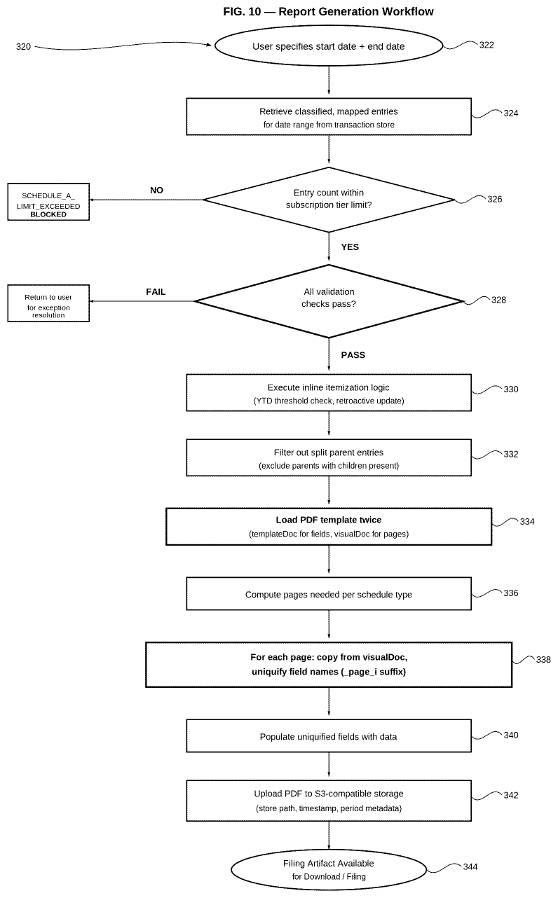

### X. Report Generation Module (FIG. 8, FIG. 10)

The report generation module (126, 320) receives validated, classified, and mapped transaction records for a specified reporting period and produces filing-ready output artifacts. The treasurer specifies the reporting period by providing a start date and an end date (322). The system retrieves all classified, mapped, and validated transaction records falling within the specified date range (324) and generates the corresponding filing output for the applicable jurisdiction.

### A. PDF Generation Architecture—Client-Side With Dual-Document Loading

In one embodiment, the PDF generation is performed on the client side using a PDF manipulation library (e.g., pdf-lib). The system loads the jurisdiction-specific PDF form template twice (278, 334), creating two independent document instances:
(a\) A first instance (“templateDoc”) (280) is used exclusively for form field definition extraction (284)—the system reads the AcroForm field metadata (field names, types, positions, and attributes) from this instance. This instance is not used for page copying.
(b\) A second instance (“visualDoc”) (282) is used exclusively for page copying (286)—the system copies pages from this instance into the output document. This instance is not used for field metadata extraction.

The dual-document loading pattern is necessitated by a technical constraint in the PDF manipulation library: the form-field extraction and page-copy operations each mutate internal document state in incompatible ways, such that performing both operations on a single document instance would cause state conflicts that corrupt the output. By maintaining two independent instances loaded from the same template, the system isolates the state mutations and ensures reliable output generation.

### B. Acroform Field-Name Uniquification

When a single reporting period requires multiple pages of the same schedule type, the system determines whether entries exceed single page capacity (288) and instantiates the template page N times (290) within a single output document. To prevent field-name collisions inherent in multi-page instantiation of a single AcroForm template, the system implements a field-name uniquification technique (292):

For each instantiated page, the system identifies all AcroForm field names on that page and appends a page-index suffix (e.g., “\_page_0”, “\_page_1”, “\_page_2”) to each field name. This produces globally unique field names across all pages of the generated document. Field values are then populated with transaction data (294, 340) by reference to the uniquified field names, ensuring that values assigned to fields on one page do not overwrite values on other pages. The pages are assembled into a single filing artifact (296).

The uniquification is performed programmatically during document assembly. The templateDoc instance (280) provides the canonical field names, and the system appends the suffix before writing field values to the output document.

### C. Validation Gate

Before generating the filing artifact, the system checks whether all validation checks pass (328). The validation process evaluates completeness of classified and mapped transaction records for the reporting period, confirming that all records have been assigned a classification category and that all required fields for the applicable jurisdiction have been populated. Generation of the filing artifact is blocked until all mandatory validation checks pass.

### D. Subscription-Tier Document Generation Control

In some embodiments, the system checks whether the entry count is within the subscription tier limit (326). When an entry count or aggregate amount exceeds the applicable tier limit, the system returns a typed error (e.g., SCHEDULE_A_LIMIT_EXCEEDED) and blocks PDF generation until the limit condition is resolved. This mechanism is implemented as a business-logic control at the application layer.

### E. Report Assembly and Storage

During report generation, the system executes inline itemization logic (330), filters out split parent entries (332), loads the PDF template twice (334), computes pages needed per schedule type (336), copies pages from visualDoc and uniquifies field names with \_page_i suffix (338), populates uniquified fields with transaction data (340), and uploads the completed PDF to S3-compatible storage with generation metadata (342). The filing artifact is then available for download or filing (344).

### F. CFA-4 and CFA-11 Report Types

In one embodiment specific to the State of Indiana, the system generates CFA-4 reports (Campaign Finance Report of Receipts and Expenditures) comprising a cover page, Schedule A pages (itemized and summary contributions), and Schedule A-5 pages (in-kind contributions). The CFA-5 designation in the user interface is a label only; Schedule A-5 is a page within the CFA-4 document structure, not a separate filing.

The system also generates CFA-11 supplemental disclosure reports (230). CFA-11generation is triggered manually by the user, who selects up to three Schedule A entries from a prior CFA-4 report via a dialog interface. The CFA-11 report stores foreign key references (source_schedule_a_entry_id_1, source_schedule_a_entry_id_2, source_schedule_a_entry_id_3) back to the source CFA-4 entries, maintaining referential integrity between the supplemental disclosure and the underlying contribution records.

### XI. Document Storage Module

The document storage module (128) stores generated filing artifacts in an object storage system (166). In some embodiments, the object storage system conforms to the S3-compatible object storage API, enabling the system to operate with any compatible storage provider without modification to the application code. Stored artifacts are retrievable by committee identifier, reporting period, and generation timestamp. Generation metadata (168) including the reporting period parameters and the generation timestamp are stored with each artifact to support audit, retrieval, and regeneration.

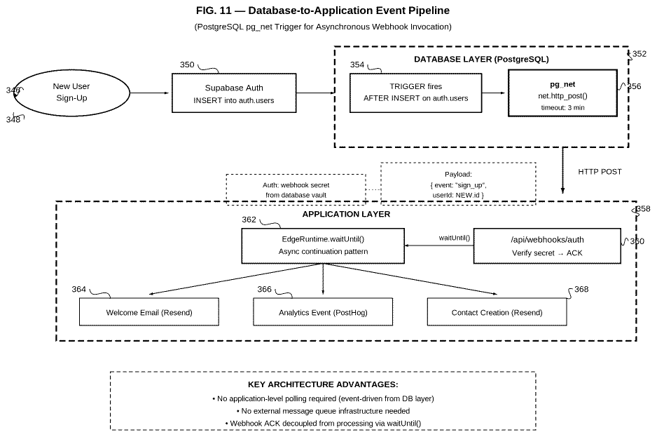

### XII. Database-To-Application Event Pipeline (FIG. 11)

The system implements a database-to-application event pipeline (346) that uses PostgreSQL database triggers in combination with a network extension (pg_net) to invoke application endpoints directly from the database layer (352) without requiring application-level polling, external message queues, or dedicated event-bus infrastructure.

In one embodiment, a new user sign-up event (348) triggers an INSERT into the auth. users table through Supabase Auth (350). A trigger is defined on the auth. users table that fires after each new row insertion (354). The trigger function invokes pg_net's http_post( ) function (356) to send an authenticated HTTP POST request to the application's internal webhook endpoint (/api/webhooks/auth) (360) in the application layer (358). The request payload includes the event type (e.g., “sign_up”) and the new user's identifier. Authentication is performed using a webhook secret retrieved from the database vault at invocation time. The invocation is configured with a three-minute timeout to prevent indefinite blocking.

The webhook handler employs an edge-runtime asynchronous continuation pattern (362) (e.g., EdgeRuntime.waitUntil( )) to immediately acknowledge receipt of the webhook event and then perform post-registration processing operations—including welcome email dispatch via Resend (364), analytics event capture via PostHog (366), and external contact creation via Resend (368)—asynchronously, decoupling the webhook response latency from the processing duration.

This architecture eliminates the need for the application to poll the database for new registration events and reduces the latency between event occurrence and event processing, while keeping the event-dispatch mechanism entirely within the database layer.

### XIII. Observability Module

The system includes an observability module (134, 170) that captures product analytics, performance metrics, and error data. In some embodiments, analytics events including user interactions, feature usage, and web performance vitals are captured by an analytics service (e.g., PostHog). In some embodiments, application errors and exceptions are captured by an error monitoring service (e.g., Sentry) with structured error grouping, alerting, and session replay capabilities. The observability module operates independently of the compliance processing pipeline and does not affect the compliance outputs.

### XIV. Alternative Embodiments and Variations

In some embodiments, the system supports multiple simultaneous committee configurations, each with independently maintained bank account connections, rule sets, mapping templates, and stored artifacts.

In some embodiments, the system supports multiple jurisdictions within a single committee configuration, maintaining separate mapping templates, form definitions, and schedule structures for each jurisdiction.

In some embodiments, the classification rule sets are configurable through the user interface without requiring modification to the application code.

In some embodiments, the system supports multiple synchronization schedules per connected account, with different schedules applicable to different times of the reporting period.

In some embodiments, the report generation module supports amendment workflows in which a previously generated artifact is retrieved, the underlying record set is modified, and a new artifact is generated with a version identifier linking it to the prior artifact.

In some embodiments, the system maintains a contributor record database that stores attributes for contributors who appear in multiple reporting periods, reducing re-entry of attributes for recurring contributors.

In some embodiments, the system includes an automated compliance calendar that maintains jurisdiction-specific filing deadlines and generates reminder notifications at configurable intervals before each deadline.

In some embodiments, the system includes per-donor contribution limit monitoring that maintains cumulative contribution totals per donor and flags entries that approach or exceed statutory limits.

In some embodiments, the system generates structured electronic filing formats (e.g., XML, CSV, or jurisdiction-specific formats) in addition to or in place of PDF outputs.

In some embodiments, the system includes a multi-user access model with role-based permissions enabling multiple users to access a single committee account with differentiated capabilities.

In some embodiments, the system provides application-layer encryption of stored financial data interface access tokens in addition to infrastructure-level encryption at rest.

In some embodiments, the system generates automated alert notifications when individual transaction amounts or aggregate contribution totals exceed configurable thresholds.

What is claimed is:

1. A computer-implemented campaign finance compliance system comprising: one or more processors; and one or more non-transitory computer-readable media storing instructions that, when executed by the one or more processors, cause the system to: establish an authenticated connection to a financial institution data interface and retrieve transaction records associated with a campaign committee bank account through the authenticated connection; normalize retrieved transaction records into a standardized internal data schema stored in a relational database; evaluate each normalized transaction record against a configurable rule set to assign a campaign finance transaction classification category to the record; for each contributor identified in classified contribution records within a calendar year, compute an aggregate year-to-date contribution total by querying classified contribution records across all reports generated for the same calendar year without filtering by report identifier; determine whether the aggregate year-to-date total for each contributor exceeds an applicable itemization threshold; when the aggregate year-to-date total for a contributor exceeds the itemization threshold, update an itemization status indicator on classified contribution records associated with that contributor across all reports within the same calendar year, including records belonging to reports previously generated; map each classified and itemized transaction record to a jurisdiction-specific compliance representation comprising a schedule identifier and populated field values; and generate at least one filing artifact comprising a structured representation of the classified, mapped, and itemized transaction records formatted in accordance with the applicable jurisdiction's reporting requirements.

2. A computer-implemented method for automated campaign finance compliance processing, comprising: establishing, by one or more processors, an authenticated connection to a financial institution data interface; retrieving transaction records associated with a campaign committee bank account through the authenticated connection; normalizing the retrieved transaction records into a standardized internal data schema; evaluating each normalized transaction record against a stored rule set to assign a campaign finance transaction classification category; computing, for each contributor identified in classified contribution records, an aggregate year-to-date contribution total scoped to a calendar year by querying records across multiple reports generated within the same calendar year; determining whether each contributor's aggregate total exceeds an applicable itemization threshold; retroactively updating an itemization status indicator on contribution records in prior reports within the same calendar year when a contributor's aggregate total exceeds the threshold due to a newly classified contribution; mapping classified transaction records to jurisdiction-specific compliance representations; and generating a filing artifact formatted according to the applicable jurisdiction's reporting form requirements.

3. A non-transitory computer-readable medium storing instructions that, when executed by one or more processors, cause the processors to perform operations comprising: retrieving classified and mapped campaign finance transaction records for a specified reporting period from a relational database; determining that a number of transaction records assigned to a particular schedule type exceeds a page capacity of a regulatory form template for that schedule type; instantiating the regulatory form template a plurality of times within a single output document, wherein each instantiation corresponds to a page of the output document; for each instantiated page, identifying all form fields defined on the page and appending a page-index suffix to each form field name to produce globally unique form field names across all pages of the output document; populating each uniquified form field with corresponding transaction record data; and assembling the plurality of instantiated pages into a single filing artifact document.

4. The system of claim 1, wherein establishing the authenticated connection comprises at least one of: (a) mutual Transport Layer Security authentication in which the system presents a client certificate to the financial institution data interface; or (b) OAuth-based token exchange in which an access token obtained through an end-user enrollment flow is stored and used to authenticate subsequent retrieval requests.

5. The system of claim 1, further comprising maintaining a dual-path synchronization architecture comprising: a first synchronization path that receives event-driven transaction notifications from the financial institution data interface through a webhook endpoint; and a second synchronization path that periodically retrieves transaction records from the financial institution data interface using cursor-based incremental retrieval; wherein the system reconciles transaction records received through both paths using upsert-on-conflict deduplication keyed on a financial-institution-assigned transaction identifier to maintain a deduplicated transaction store.

6. The system of claim 5, wherein a webhook handler for the first synchronization path employs an asynchronous continuation pattern that returns an acknowledgment response to the financial institution data interface before completing synchronization processing, decoupling response latency from processing duration.

7. The system of claim 1, wherein computing the aggregate year-to-date contribution total further comprises: for each classified contribution record, determining whether the record represents a deposit placeholder; when the record represents a deposit placeholder, using the record's unique identifier as a grouping key for aggregation; and when the record does not represent a deposit placeholder, using a normalized contributor name as the grouping key for aggregation.

8. The system of claim 1, further comprising a split-transaction module configured to: receive user input designating a parent transaction record for decomposition; create one or more child transaction records, each referencing the parent record through a self-referential foreign key; and during filing artifact generation, automatically exclude parent transaction records from the output when one or more child records referencing that parent are present.

9. The system of claim 8, wherein the self-referential foreign key references a universally unique identifier (UUID) primary key of the parent record, and wherein the split depth is limited to one level such that a child record cannot itself serve as a parent for further decomposition.

10. The system of claim 1, wherein the filing artifact comprises a PDF document, and wherein generating the filing artifact comprises: loading a jurisdiction-specific PDF form template into a first document instance for form field metadata extraction and into a second document instance for page copying; copying pages from the second document instance into an output document; and populating form fields using metadata extracted from the first document instance; wherein the dual-document loading isolates mutually incompatible state mutations caused by form-field extraction and page-copy operations in a PDF manipulation library.

11. The method of claim 2, further comprising: loading a PDF form template; instantiating the template a plurality of times within a single output document; for each instantiated page, appending a page-index suffix to each AcroForm field name to produce globally unique field names; and populating each uniquified field with transaction record data.

12. The system of claim 1, wherein the classification module further comprises an automated intermediary identification sub-module that: compares a merchant name field of each transaction record against one or more stored platform identifier strings associated with known contribution aggregation platforms; and when a match is detected, designates the aggregation platform as the contributor entity and normalizes the contributor display name.

13. The system of claim 1, further comprising a database-to-application event pipeline comprising: a database trigger defined on a user registration table that fires upon insertion of a new user record; wherein the trigger invokes an asynchronous HTTP POST request to an application webhook endpoint using a database network extension, the request authenticated by a secret stored in a database vault; and wherein the application processes the registration event asynchronously without application-level polling or external message queue infrastructure.

14. The non-transitory computer-readable medium of claim 3, wherein loading the regulatory form template comprises creating two independent document instances from the same template file: a first instance used for form field metadata extraction and a second instance used for page copying, the two instances isolating mutually incompatible document state mutations.

15. The system of claim 1, wherein the system further generates a supplemental disclosure report by: receiving user selection of up to a defined maximum number of contribution records from a previously generated filing artifact; creating a supplemental report record storing foreign key references to the selected contribution records; and generating a supplemental filing artifact incorporating data from the referenced contribution records.

16. The method of claim 2, wherein the configurable rule set comprises at least one of: exact string matching against a counterparty name field; numeric threshold evaluation against a transaction amount field; pattern matching against a memo or description field; and comparison against prior classification decisions for transactions from the same counterparty.

17. The system of claim 1, wherein the instructions further cause the system to, for each normalized transaction record that does not yield a confident classification from the configurable rule set, invoke a heuristic analysis layer that surfaces one or more candidate classification categories with associated confidence scores for presentation to an authorized user through a review interface, wherein the system does not automatically apply a heuristic classification without user confirmation.

18. The system of claim 1, wherein generating the filing artifact further comprises: executing a validation process that evaluates completeness of classified and mapped transaction records for the reporting period, the validation process confirming that all records have been assigned a classification category and that all required fields for the applicable jurisdiction have been populated; and blocking generation of the filing artifact until all mandatory validation checks pass.

19. The system of claim 1, wherein the generated filing artifact and associated generation metadata are stored in an S3-compatible object storage system, and wherein the generation metadata comprises at least a generation timestamp, a reporting period identifier, and a reference to the committee account, supporting retrieval, audit, and regeneration of the artifact.

20. The non-transitory computer-readable medium of claim 3, wherein the operations further comprise enforcing a tier-differentiated generation control that blocks generation of the filing artifact when a count of transaction records assigned to a schedule type exceeds a limit associated with the user's subscription tier.
